(19) United States
(12) Patent Application Publication
(10) Pub. No.: US 2012/0140213 A1
(43) Pub. Date: Jun. 7, 2012

(54) STATIC DESALTER SIMULATOR

(75) Inventors: Cato Russell McDaniel, The Woodlands, TX (US); Karl Kuklenz, The Woodlands, TX (US); Kurt Ginsel, The Woodlands, TX (US)

(73) Assignee: GENERAL ELECTRIC COMPANY, Schenectady, NY (US)

(21) Appl. No.: 12/958,656

(22) Filed: Dec. 2, 2010

(51) Int. Cl. G01N 21/01

(52) U.S. Cl. 356/246

(57) ABSTRACT

A small-scale static simulator for crude oil refinery desalters has an oil bath, a portion of which is made of a transparent material, a heater/circulator configured to control the temperature of the oil bath and an emulsion-forming device. The desalter simulator also includes a plurality of mixing tubes, each mixing tube having a cap member with a blending assembly configured to work with the emulsion-forming device to emulsify an oil/water mixture contained in the mixing tube. A tube-holding rack is received in the oil bath. The tube-holding rack has a plurality of parallel plates, said plates having openings forming mixing tube receiving apertures. The desalter simulator includes at least one light source positioned adjacent to the oil bath, wherein the light source comprises an under light positioned beneath the oil bath configured to direct light into each of the mixing tubes located in the tube-holding rack, wherein the light source is directed through the transparent portion to aid in visualization and testing of the demulsification process. The desalter simulator also includes a power supply, wherein the plates of the tube-holding rack are connected to the power supply to form an electric grid adjacent the mixing tubes.

### BACKGROUND OF THE INVENTION

1. Field of the Invention

The present invention relates generally to the small-scale simulation of crude oil refinery desalters, free water knockouts and heater treaters, and more particularly, to a static desalter simulator that enables the direct observation of the emulsion.

2. Description of Related Art

Liquid hydrocarbon phase, such as crude oil, naturally contains a variety of contaminants that have detrimental effects on process equipment and in the operation of a refinery. These contaminants are broadly classified as salts, bottom sediment, water, solids, and metals. The types and amounts of these contaminants vary, depending on the particular hydrocarbon phase. Additionally, native water present in the liquid hydrocarbon phase as droplets may be coated with naturally occurring surfactants such as asphaltenes, naphthenic acid salts, resins, or with solids including but not limited to iron oxide, silica, carbon, carbonates, or phosphates. Removing the water from the crude oil is essential at crude oil production facilities as it impacts the value of crude oil and its economic transportation. The presence of salts, especially chlorides of Group I and Group II elements of The Periodic Table of Elements, causes corrosion of oil processing equipment. In order to mitigate the effects of corrosion, it is advantageous to reduce the salt concentration to the range of 1 to 5 ppm or less and water content to about 0.10 to 1 wt % by weight of the crude oil prior to transportation and processing of the oil.

A standard treatment for removing small particles of solids and bottom sediment, salts, water and metals is a phase separation operation commonly known as dewatering or desalting. A fresh water wash in the range of typically 4 to 15 vol % is injected into the crude oil. The crude oil and wash water are subjected to shear to thoroughly mix the water and the crude oil to form an emulsion and to transfer the contaminants from the crude oil into the fresh water. Frequently, a chemical emulsion breaker is also added to the emulsion, and often the emulsion is subjected to an electrostatic field so that water droplets in the mixture of crude oil, wash water, and chemical emulsion breaker coalesce in the electrostatic field between electrodes. The coalesced water droplets settle below the oleaginous crude oil phase and are removed. The treated crude oil is removed from the upper part of the separator.

One problem encountered with dewatering and desalting is that some crude oils form an undesirable “rag” layer comprising a stable oil-water emulsion and solids at the water-oil phase boundary in the desalter vessel. The rag layer often remains in the vessel but it may be removed for storage or for further processing. Rag layers at the water-oil phase boundary result in oil loss and reduced processing capacity. Heavy crude oils containing high concentrations of asphaltenes, resins, waxes, and napthenic acids exhibit a high propensity to form rag layers.

Additives may be added to improve coalescence and dehydration of the hydrocarbon phase, provide faster water separation, improve salt or solids extraction, and generate oil-free effluent water. These additives, also known as demulsifiers, are usually fed to the hydrocarbon phase to modify the oil/water interface. It is also possible to feed these materials to the wash water or to both the oil and water. These additives allow droplets of water to coalesce more readily and for the surfaces of solids to be water-wetted. The additives reduce the effective time required for good separation of oil, solids, and water.

Development of new chemical demulsifiers has typically been done using a simple apparatus such as glass bottles or glass tubes and is referred to as “bottle testing”. In the simplest embodiment, oil samples with treatments are added to prescription bottles and shaken. The rate of demulsification (water removal) is then monitored as a function of time by observing the amount of “free” water that collects at the bottom of the bottle. These methods have proven to be useful but they often fail to adequately simulate many critical parameters of a desalter and have been of limited use particularly in heavy oils or systems that have a propensity to develop rag layers.

It is desired to improve simulation methods such that one may select the most efficacious chemistries and operating conditions to optimize the emulsion breaker chemistries, oil mixtures, temperatures, emulsion size, and other parameters.

### SUMMARY OF THE INVENTION

In one aspect, the invention is directed to a small-scale static simulator for crude oil refinery desalters. The desalter simulator includes an oil bath, a portion of which is made of a transparent material, a heater/circulator configured to control the temperature of the oil bath and an emulsion-forming device. The desalter simulator also includes a plurality of mixing tubes, each mixing tube having a cap member with a blending assembly configured to work with the emulsion-forming device to emulsify an oil/water mixture contained in the mixing tube. A tube-holding rack is received in the oil bath. The tube-holding rack has a plurality of parallel plates, said plates having openings forming mixing tube receiving apertures. The desalter simulator includes at least one light source positioned adjacent to the oil bath, wherein the light source comprises an under light positioned beneath the oil bath configured to direct light into each of the mixing tubes located in the tube-holding rack, wherein the light source is directed through the transparent portion to aid in visualization and testing of the demulsification process. The desalter simulator also includes a power supply, wherein the plates of the tube-holding rack are connected to the power supply to form an electric grid adjacent the mixing tubes. In one embodiment, the desalter simulator also includes an imaging device used to record the separation of the oil and water in the mixing tubes.

The present invention and its advantages over the prior art will become apparent upon reading the following detailed description and the appended claims with reference to the accompanying drawings.

### BRIEF DESCRIPTION OF THE DRAWINGS

The above mentioned and other features of this invention will become more apparent and the invention itself will be better understood by reference to the following description of embodiments of the invention taken in conjunction with the accompanying drawings, wherein:

FIG. 1 illustrates a perspective view of a desalter simulator apparatus according to an embodiment of the invention;

FIG. 2 illustrates a mixing tube used in the desalter simulator apparatus of FIG. 1;

FIG. 3 illustrates a blending mechanism attached to the mixing tube of FIG. 2;

FIG. 4 illustrates another embodiment of a mixing tube used in the desalter simulator apparatus of FIG. 1;

FIG. 5 illustrates a tube rack used in the desalter simulator apparatus of FIG. 1; and

FIG. 6 illustrates a light source used in the desalter simulator apparatus of FIG. 1.

Corresponding reference characters indicate corresponding parts throughout the views of the drawings.

### DETAILED DESCRIPTION OF THE INVENTION

The invention will now be described in the following detailed description with reference to the drawings, wherein preferred embodiments are described in detail to enable practice of the invention. Although the invention is described with reference to these specific preferred embodiments, it will be understood that the invention is not limited to these preferred embodiments. But to the contrary, the invention includes numerous alternatives, modifications, and equivalents as will become apparent from consideration of the following detailed description.

A desalter simulator apparatus 10 provides the ability to test emulsion breaker chemistries using different oil mixtures, temperatures, emulsion size, and other parameters. The desalter simulator apparatus 10 uses small amounts of oil to perform the experiments, thereby reducing the cost of oil transport and disposal. In the desalter simulator apparatus 10, chemical demulsifiers are added to the crude oil and/or wash water, and these are mixed together at a temperature and with a shear and duration approximating that of a mix valve of an industrial desalter to simulate actual field conditions. Then the emulsion is allowed to settle at a temperature and electric field strength and for a residence time approximating that of the desalter.

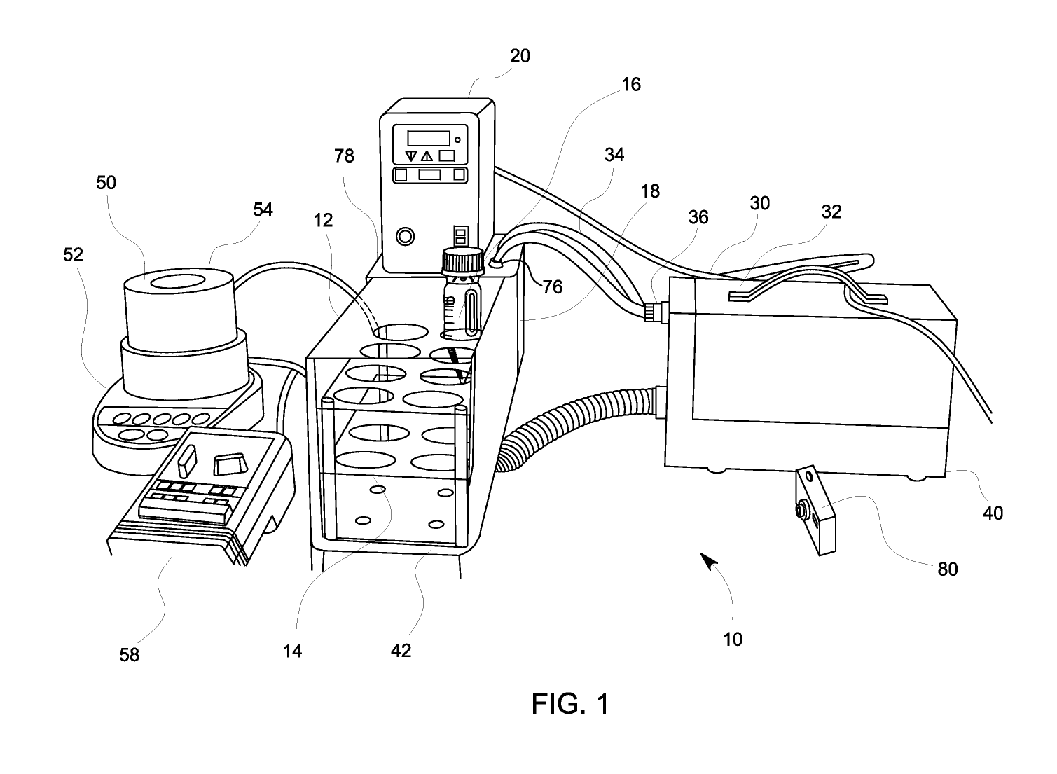

Referring now to FIG. 1, the desalter simulator apparatus 10 contains an oil bath 12 having a rack 14 positioned therein configured to receive a plurality of mixing tubes 16. In the illustrated embodiment, the oil bath 12 has four generally rectangular sides 18 and is open at the top to provide access to the mixing tubes 16. Desirably, the mixing tubes 16 and oil bath 12 are made of glass or other substantially transparent material so that the operator may visually monitor the demulsification of the samples to obtain experiment results. A heater/circulator 20 controls the temperature of the oil bath 12 and permits the emulsion samples to be preheated up to temperature which will best emulate the conditions inside an industrial size desalter. The desired temperature of the oil bath 12 is typically in the range of about 200 and 300° F. This enables the emulsions in the mixing tubes 16 to be tested at pressures of about 50 psig. Suitable examples of heater/circulators 20 are the Haake DC-3 or DC-30 available from Thermo Fisher Scientific Inc. of Waltham, Mass. Desirably, the heater/circulator 20 is fixed to the wall of the oil bath 12 and has a pump (not shown) with a swivel-mounted pump nozzle (not shown) to aid in circulation, and therefore, temperature uniformity throughout the oil bath 12. Desirably, the heating fluid circulated in the oil bath is a silicon based oil. In one embodiment, Maxima C Plus vacuum pump oil, also available from Thermo Fisher Scientific Inc., is used as the heating fluid in the oil bath 12. However, one skilled in the art will understand that other fluids may be use as the heating fluid for the oil bath 12.

The desalter simulator apparatus 10 contains a power supply 30 located in a suitable power supply box 32. In one embodiment, the power supply 30 is a high voltage transformer with a 10 KV AC output. High voltage leads 34 are connected to the power supply 30 with a three-prong plug 36. In one embodiment, the middle prong plug is for electrical output (hot side) and the two side prong plugs are for groundside.

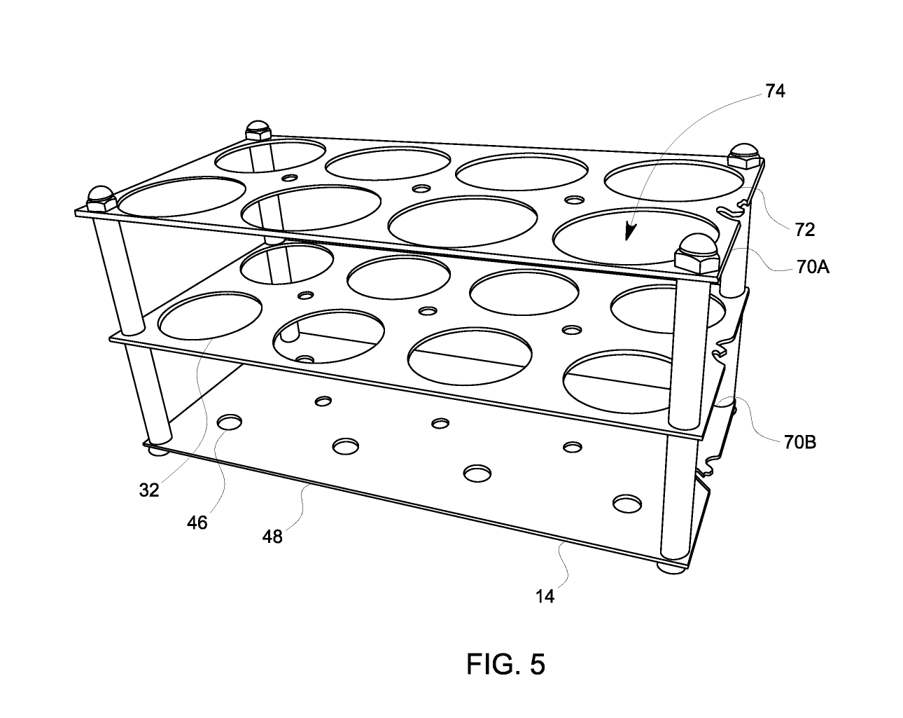

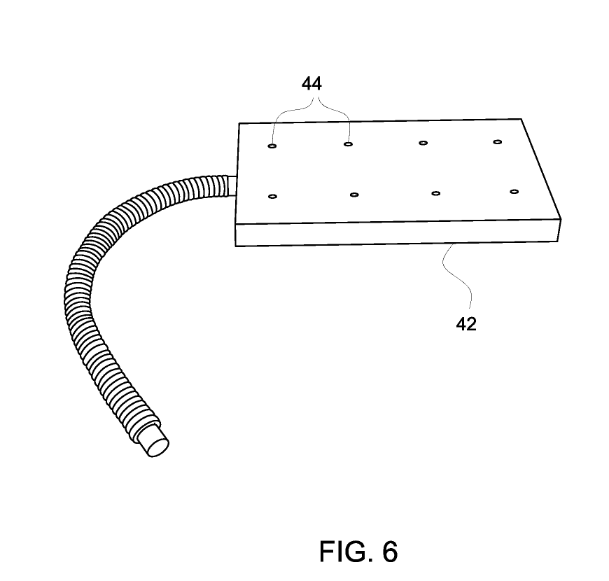

The desalter simulator apparatus 10 also contains a light source 40 adjacent the oil bath 12 to illuminate the mixing tubes 16 and aid in observation of the demulsification process. In one embodiment, the light source 40 is a fiber optic light source built into the power supply box 32 that connects to an under light 42 positioned beneath the oil bath 12. As best seen in FIG. 6, the under light 42 has a plurality of light guides 44 that direct light into each of the mixing tubes 16 in the rack 14 through holes 46 (FIG. 5) in a bottom plate 48C of the rack 14. However, one skilled in the art will understand that the light source 40 may produce light in the visible light, near IR, and/or UV spectrums and can be of any design known to those skilled in the art. Thus, the transparent oil bath 12 allows observation of the demulsification process using not only the visible light spectrum, but also the IR and near IR light spectrums. The transparent oil bath 12 permits observation of the effects that changing emulsion breaker chemistries, operating conditions, oil mixtures, temperatures, emulsion size, and other parameters have on the process.

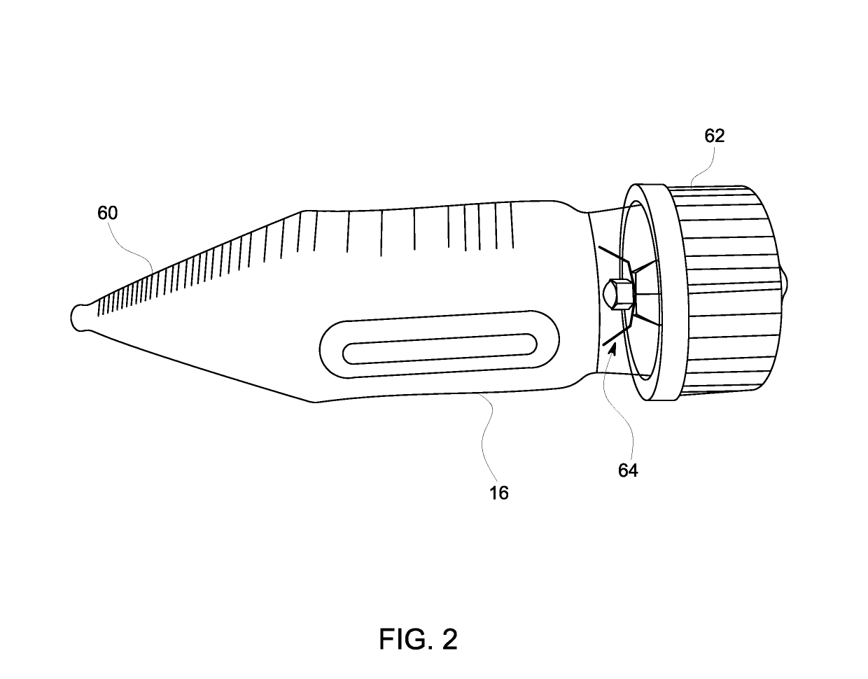

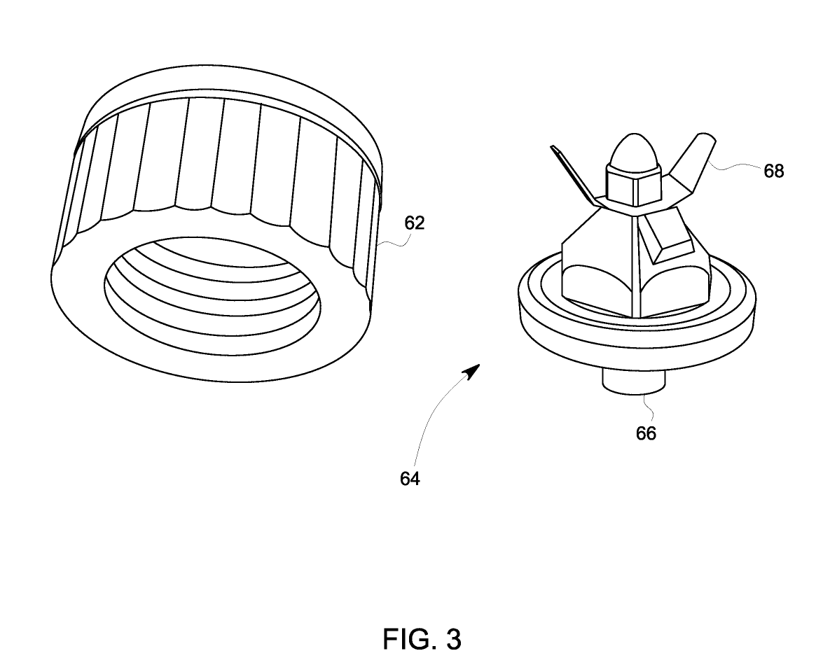

As best seen in FIGS. 2 and 3, the desalter simulator apparatus 10 contains an oil/water emulsion-forming device 50. In one embodiment, the emulsion-forming device 50 is an electrically variable stirring device made from a modified commercial blender. The emulsion-forming device 50 has a blender base 52, for example, a Kitchen Aid® blender base, with an adapter 54. In one embodiment, the adapter 54 contains a direct gear drive mechanism that converts a single mixer spindle of the blender base 52 to one that accommodates a plurality of mixing tubes 16 simultaneously. Alternately, the adapter 54 may be connected individually to each tube 16 to emulsify the oil/water mixture therein. One skilled in the art will understand that the adapter 54 may be constructed in various ways using sound engineering judgments. Mixing speed is, optionally, controlled using a variable transformer connected to the blender motor. The duration of mixing is optionally controlled by any conventional electronic device timer 58 suitable for precision timing of the on/off switching of an electrical appliance. The operator can select the velocity or stirring rate of the emulsion-forming device to vary the tightness of the emulsion. Suitable timers 58 are available from GraLab of Centerville, Ohio. In one embodiment, the emulsion forming device 50 speed settings at 4,000, 7,000, 10,000, 13,000, and 16,000 RPM. It has been found that in a 100 ml mixing tube 16, the relation of the each 1,000 rpm/2 sec=1 psi of the mix valve of a desalter.

### EXAMPLES

mix valve 10 psi: Select 10,000 rpm/2 sec

mix valve 20 psi: Select 10,000 rpm/3 sec

mix valve 13 psi: Select 13,000 rpm/2 sec

mix valve 16 psi: Select 16,000 rpm/2 sec

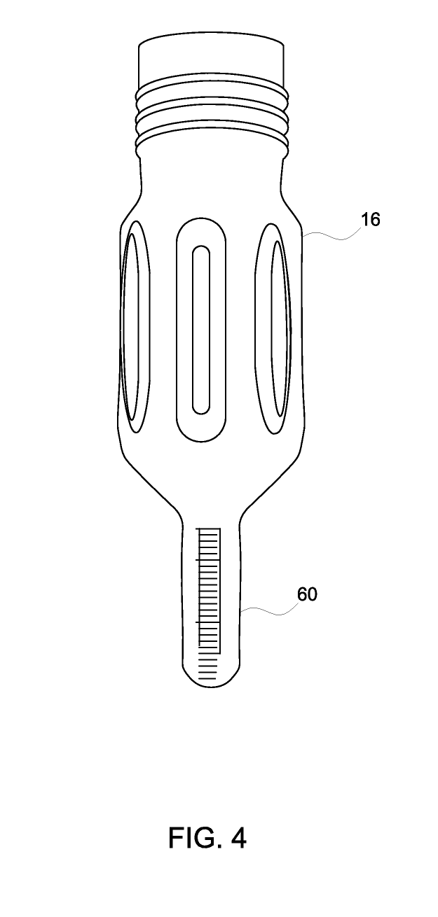

The mixing tubes 16 are desirably made of glass since this permits visible inspection and prevents any significant electrical conduction. The mixing tubes 16 are of sufficient thickness to not break under normal usage in the desalter simulator apparatus 10. Two millimeters or more of thickness is typically sufficient. The volume of the tubes can vary but the size and shape must match up with the tubular recesses in the tube rack 14. About 100 ml or more is typical. FIG. 4 illustrates one desirably embodiment of a mixing tube 16. The mixing tube 16 has a graduated tip 60 rather than a conical tip to improve the precision at which measurements may be read. Sides of the mixing tube 16 have Morton indentations to promote better agitation of the oil/water mixture.

The mixing tubes 16 accept a cap member 62 removably/threadably attached to the open end of mixing tube with Teflon® rings. The cap member 62 is fitted with a blending assembly 64. As best seen in FIG. 3, the blending assembly 64 is a built-in mixer-bushing assembly. One suitable example of the cap member 62 is a GL-45 stirred reactor cap from Schott AG of Mainz, Germany. As best seen in FIG. 3, the blending assembly 64 is received in the cap 62 and has a central shaft member 66 and mixer blades 68. A variety of mixer blade designs and shaft lengths can be attached to the mixer-bushing assembly inside the mixing tubes 16. Typically, a 4-fin stainless steel paddle blade 68 may be used. The central shaft 66 is connected to the blender adapter.

As best seen in FIG. 5, one embodiment of the tube rack 14 is made of a plurality of substantially parallel plates 48A, 48B. and 48C. Plates 70A, 70B have a plurality of recesses 72 formed therein and the recesses of adjacent plates are aligned so as form tubular apertures 74 configured to hold the mixing tubes 16 in an upright manner. In one embodiment, the tube rack 14 is configured to hold multiple mixing tubes 16. Therefore, testing on a specific crude oil composition can be conducted simultaneously using several different emulsion breaker chemistries, concentrations, and conditions to see which combination provides the most effective treatment.

The plates 48A, 48B and 48C have tabs 70 for attachment of the electrical leads 34 from the power supply 30 so that an electric field is formed adjacent the mixing tubes 16. In one desirable embodiment, the middle plate 48B is electrically energized while the top plate 48A and bottom plate 48C are grounded. Plastic spacers 71 electrically isolate the plates 48A, 48B and 48C. This causes two electric fields to be generated, one between the top and middle plates 48A, 48B, and one between the bottom and middle plates 48C, 48B. The high voltage leads 34 connect the power supply 30 to the tube rack 14 through holes 76 in bridge 78. In the illustrated embodiment, a top ground passes through a rear hole to the top plate 48A, a high voltage middle lead passes through a middle hole to the middle plate 48B, and a bottom ground passes through a front hole to the bottom plate 48C. Care should be taken such that the leads 34 do not touch heating coils of the heater/circulator 20. Desirably, the plastic spacers 71 are made from a plastic having high mechanical, thermal, and electrical properties so as to withstand the heat, exposure to silicone oil heating fluids, and dielectric breakdown caused by the oil bath environment. One example is Ultem® polyetherimide, available from SABIC Innovative Plastics.

The plates 48A, 48B and 48C form an electric grid that generates an electrostatic field at potentials ranging from about 6,000 volts to about 10,000 volts (RMS) to induce dipole attractive forces between neighboring droplets, which causes them to migrate towards each other and coalesce. Once emulsions of suitable drop size distribution are prepared, the samples are exposed to the electric field. The electrostatic field causes each droplet to have a positive charge on one side and a negative charge on the other. The droplets coalesce because of the attractive force generated by the opposite charges on neighboring droplets. The attractive force is strongly affected by the distance between the droplets and is much stronger when the droplets are in close proximity. Various geometries can be used to accommodate various pluralities of tubes. In one embodiment, up to eight mixing tubes 16 can be run at a time.

The crude oil residence time in the mixing tube is desirably between about 15 and 30 minutes. This corresponds to typical residence times for desalters treating crude oil with API gravities from 15 to 28. The larger coalesced droplets settle by gravity into the water phase and are measured in the graduated portion at the bottom of the mixing tube.

In one embodiment, an imaging device 80 is used to record the demulsification. The imaging device 80 may be a digital camera or other recording device used to record the separation of the oil and water in the mixing tubes 16. The digital camera 80 can be operated manually or by using a controller (not shown) to record images at desired time intervals such that the operator need not be present during the entire time necessary to separate the emulsion. Accordingly, photography and image analysis may be used rather than visual inspection to collect the data.

The invention is also directed to a method of using the desalter simulator to select demulsifiers for refinery crude oil desalters. In one embodiment, the same oil/water ratio as found in the desalter system to be modeled is used, and the amount of water, which drops out of the emulsion as a function of time, is recorded and averaged. The treatment with the highest mean water drop and least residual emulsion is selected. In addition, in some cases, the reverse of the desalter system's oil/water ratio is used, and the clarity of the water as a function of time is recorded. The treatment with the fastest and most complete oil rise is selected.

In performing tests with raw crude, the crude should be mixed well by a shaker for at least 15 minutes. If a low shear sampler (LSS) is available, the crude should be poured into the LSS and stirred at the minimum setting, which will vortex the whole sample for at least 15 minutes. The crude is then transferred into the mixing tubes 16 while dispensing. Tests are performed such that the BS&W, specific gravity of the crude, and pH of the wash water are measured. (BS&W is an abbreviation for Basic or Bottom Sediment & Water. It is a measure of the non-asphaltic solids and water (often mostly water) present in a hydrocarbon sample.) The process temperature, the ratio of wash water, the mix valve pressure and setting of the electrical field are also recorded.

### EXAMPLE

In order to assess the emulsion-breaking efficacy of the candidate materials, simulated desalter tests were undertaken using the desalter simulator apparatus 10. The desalter simulator apparatus 10 comprises the oil bath 12 reservoir provided with a plurality of mixing tubes 16 dispersed therein. The temperature of the oil bath 12 can be varied to about 250° F. to simulate actual field conditions. The mixing tubes 16 are placed into an electrical field to impart an electrical potential through the test emulsions.

The conditions of the process were:

Process Temperature: 250° F.

Water Ratio: 5%

Mix valve pressure: 10 psi

Grids on

Pre-heat the oil bath 12 to 250° F.

The blender was set to 10,000 rpm, and the Timer for 2 seconds

5 ml of the wash water was added to the tube

95 ml of the crude was added to the tube. Treat the tube with oil-based chemical to oil phase.

The mixing tube was capped and placed into the pre-heated oil bath 12 for 18 minutes.

The electrical field was turned on, and the tubes were emulsified (10,000 rpm/2 sec=10 psi).

The water drop in each tube was recorded after 1, 2, 4, 8, 16, 32 minutes. The interface, and the clarity of the water layer were also recorded. The mean water drop (Mean WD) was calculated. The product having the largest mean WD is typically the most desirable product.

Accordingly, the desalter simulator apparatus 10 permits the operator to simulate useful parameters including but not limited to: desalter vessel temperatures, residence time and electric fields. The emulsion is resolved in the mixing tubes 16 with the assistance of the emulsion breaking chemicals and may also be assisted by the known method of providing an electrical field to polarize the water droplets. Once the emulsion is broken, the water and petroleum media form distinct phases. A water phase is separated from a petroleum phase and subsequently monitored in the measuring portion of the mixing tube.

While the disclosure has been illustrated and described in typical embodiments, it is not intended to be limited to the details shown, since various modifications and substitutions can be made without departing in any way from the spirit of the present disclosure. As such, further modifications and equivalents of the disclosure herein disclosed may occur to persons skilled in the art using no more than routine experimentation, and all such modifications and equivalents are believed to be within the scope of the disclosure as defined by the following claims.

What is claimed is:

1. A desalter simulator for testing comprising:
an oil bath, a portion of which is made of a transparent material;
a heater/circulator configured to control the temperature of the oil bath;
an emulsion-forming device;
a plurality of mixing tubes, each mixing tube having a cap member with a blending assembly configured to work with the emulsion forming device to emulsify an oil/water mixture contained in the mixing tube, and wherein the mixing tubes have graduated tips;
a tube-holding rack received in the oil bath, the tube-holding rack forming a plurality of mixing tube receiving apertures;
at least one light source positioned adjacent to the oil bath, wherein the light source comprises an under light positioned beneath the oil bath configured to direct light into each of the mixing tubes located in the tube-holding rack, wherein the light source is directed through the transparent portion to aid in visualization and testing of the demulsification process; and
a power supply, wherein the power supply is electrically connected to the tube-holding rack to form an electric grid adjacent the mixing tubes.

2. The desalter simulator of claim 1 further comprising an imaging device used to record the separation of the oil and water in the mixing tubes.

3. The desalter simulator of claim 1 wherein the light source is a fiber optic light source with a plurality of light guides.

4. The desalter simulator of claim 1 wherein the tube-holding rack comprises a plurality of parallel plates, said plates having openings forming said mixing tube receiving apertures.

5. The desalter simulator of claim 4 wherein the plates of the tube-holding rack are connected to the power supply to form the electric grid adjacent the mixing tubes.

6. (canceled)
